(19) United States
(12) Patent Application Publication
(10) Pub. No.: US 2013/0232686 A1
(43) Pub. Date: Sep. 12, 2013

(54) POWER ASSISTED TOILET SEAT

(71) Applicants: Eli Schwartz, Herzeliya (IL); Giora Nir, Herzeliya (IL)

(72) Inventors: Eli Schwartz, Herzeliya (IL); Giora Nir, Herzeliya (IL)

(73) Assignee: SAHAR G.N. INTERNATIONAL LTD., Herzeliya (IL)

(21) Appl. No.: 13/988,324

(22) PCT Filed: Nov. 14, 2011
(86) PCT No.: PCT/IL11/00876

§ 371 Date: May 17, 2013

Related U.S. Application Data
(60) Provisional application No. 61/414,903, filed on Nov. 18, 2010.

(51) Int. Cl. A61G 7/10

(52) U.S. Cl. CPC A61G 7/1007
USPC 4/667

(57) ABSTRACT

A power-assisted toilet seat including a lifting and tilting structure that facilitates movement of the toilet seat in a path with a close approximation to the movement of the hips, buttocks, thighs, knees and lower legs, occurring when a person, being supported by the toilet seat, moves between a standing position and a sitting position. Preferably, the power-assisted toilet seat further includes a mechanism for adjusting the height of the seat in the seat's upper most position, to fit the seat's height to the height of the person using the power-assisted toilet seat. The power-assisted toilet seat may further include a device for moving the legs and knees of a sitting person upwardly, thereby bringing the person proximal to a squat position, thereby assisting a person suffering, for example, from constipation.

### RELATED APPLICATION

The present application claims the benefit of U.S. provisional application 61/414,903 filed on Nov. 18^{th}, 2010, the disclosure of which is incorporated herein by reference.

### FIELD OF THE INVENTION

This invention relates to power assisted toilet seats that enable the elderly and the disabled to ease the use of toilets. More particularly, the present invention relates to a power assisted toilet seat including a lifting and tilting structure that facilitates movement of the toilet seat in a path with a close approximation to the movement of the hips, buttocks, thighs, knees and lower legs, occurring when a person, being supported by the toilet seat, moves between a standing position and a sitting position.

### BACKGROUND OF THE INVENTION AND PRIOR ART

It is well known that individuals having certain handicaps, especially the elderly, have trouble using the toilet, since it is difficult to move between a standing and sitting position in relation to a conventional toilet seat, and often, such a person needs to obtain assistance when moving between sitting and standing positions.

Prior art toilet seats lifting devices suffer from a variety of setbacks. For example, U.S. Pat. No. 5,848,447, given to Blair W. Lindsay, discloses a device for raising and lowering a toilet seat, in which the front end of the seat is pivotely affixed at the front end side of the seat and thereby, an elderly seating on the seat may slide forward before reaching a stable standing position.

U.S. Pat. No. 6,754,917, given to Delbert R. Rhoades, discloses a complex system which provides no forward movement of the seat and thereby does not facilitates movement of the toilet seat in a path closely approximating the movement of the hips, buttocks, thighs, knees and lower legs which occurs when a person, being supported by the toilet seat, moves between a standing position and a sitting position.

There is a need, and it would be advantageous to have a power assisted toilet seat providing a toilet seat lifting and tilting structure that facilitates movement of the toilet seat in a path that closely approximates the movement of the hips, buttocks, thighs, knees and lower legs, occurring when a person, being supported by the toilet seat, moves between a standing position and a sitting position. It would be further advantageous for the power assisted toilet seat to provide a mechanism for adjusting the height of the seat in the seats upper most position, to fit the seat's height to the height of the person using the power assisted toilet seat.

### SUMMARY OF THE INVENTION

By way of introduction, the principal intentions of the present invention include proving a power-assisted toilet seat that facilitates movement of the toilet seat in a path that closely approximates the movement of the hips, buttocks, thighs, knees and lower legs, occurring when a person moves between a standing position and a sitting position.

An aspect of the present invention is to provide a mechanism for adjusting the height of the seat in the seats upper most position, to fit to the height of the person using the power-assisted toilet seat.

Another aspect of the present invention is to provide the power-assisted toilet seat with a device for moving the legs and knees of a sitting person upwardly, thereby bringing the person proximal to a squat position.

According to the teachings of the present invention there is provided a power-assisted toilet seat, including a seat-support-assembly having a U-shaped seat-support-panel, wherein the hands of the U-shaped seat-support-panel are pointing towards the front of the toilet seat bowl, side-walls, and two motion conveying arms: a lower-conveying-arm and an upper-conveying-arm. The U-shaped seat-support-panel is facilitated to securely carry a conventional toilet seat.

The power-assisted toilet seat further includes a stationary frame-assembly, facilitated to securely attach to the top of the toilet seat bowl through the common bores conventionally used to attach a conventional toilet seat. The frame-assembly includes a U-shaped bowl-top sub-frame disposed substantially parallel to the top rim of the toilet seat bowl, wherein the hands of the U-shaped bowl-top sub-frame are pointing towards the front of the toilet seat bowl; two frontal arms disposed in a general vertical orientation, one on each side of the toilet seat bowl; and a leg holder disposed at the front of the toilet seat bowl proximal and substantially parallel to the floor.

The power-assisted toilet seat further includes a lifting-mechanism for lifting and lowering the seat-support-assembly. The lifting-mechanism includes a pair of generally vertical compound jackscrews, wherein a bottom end of each of the jackscrews is pivotally attached to the bottom section of the frontal arm, respectively, at a preconfigured location; and wherein a top end of each of the jackscrews is pivotally attached to the U-shaped seat-support-panel, at preconfigured locations. The lifting-mechanism further includes a motor, rotatably connected to the compound jackscrews. Preferably the lifting-mechanism includes a pair of motors, each operatively coupled with one of the compound jackscrews. The motors may be AC or DC electric motors.

The power-assisted toilet seat further includes power switch, being in operational communication with the motor. The power switch facilitates a user to activate the compound jackscrews to thereby move a user seating on the U-shaped seat-support-panel between the standing position and the sitting position.

The top section of each of the frontal arms is securely attached to the bowl-top sub-frame proximal to the front end of the hands of the U-shaped bowl-top sub-frame.

The bottom section of each the frontal arms is securely attached to a respective end of the leg holder.

A rear end of each of the lower-conveying-arm is pivotally attached to the bottom section of the side wall, respectively, at a preconfigured location, wherein a front end of each of the lower-conveying-arm is pivotally attached to the top section of the frontal arm, respectively, at a preconfigured location. A rear end of each of the upper-conveying-arm is pivotally attached to the bottom section of the side wall, respectively, at a preconfigured location; and wherein a front end of each of the upper-conveying-arm is pivotally attached to the top section of the frontal arm, respectively, at a preconfigured location.

Preferably, the power-assisted toilet seat further includes least one arm-rest-assembly, preferably two. Preferably, a power switch is disposed at preconfigured location on each of the arm-rest-assemblies. Preferably the preconfigured location is conveniently accessible to the user.

Rotating the motor in a first direction, lifts the U-shaped seat-support-panel from the sitting position to the standing position, and wherein rotating the motor in a second direction, lowers the U-shaped seat-support-panel from the standing position to the sitting position.

Optionally, the power-assisted toilet seat as in claim further includes a height adjustment mechanism, having a rigid element and a flexible contact arm, wherein the rigid element is operatively connected to the U-shaped seat-support-panel, wherein the flexible contact arm is in operational communication with the motor, and wherein when the U-shaped seat-support-panel reaches a preconfigured height, the rigid element activates the flexible contact arm to thereby deactivate the motor.

Optionally, the power-assisted toilet seat further includes a feet-lifting-device for moving the legs and knees of a sitting person upwardly. The feet-lifting-device includes a lifting-tray, a tray-lifting mechanism, and an activating-switch. The tray-lifting mechanism is in operational communication with the lifting-tray; and wherein the activating-switch is in operational communication with the tray-lifting mechanism.

The tray-lifting mechanism includes a motion conveying bar, a second-jackscrew, and a motor. Activating the activating-switch activates the motor to rotatably activate the second jackscrew to thereby move the lifting-tray in a generally vertical direction. Rotating the motor in a first direction, lifts the U-shaped seat-support-panel from the sitting position to the standing position, and wherein rotating the motor in a second direction, lowers the U-shaped seat-support-panel from the standing position to the sitting position.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 is a perspective view illustration of a power-assisted toilet seat for disabled persons, according to embodiments of the present invention, wherein the power-assisted toilet seat is shown in the lower most position;

FIG. 2a is a front view illustration of the power-assisted toilet seat, as shown in FIG. 1;

FIG. 2b is a side view illustration of the power-assisted toilet seat, as shown in FIG. 1;

FIG. 3 is a perspective view illustration of a power-assisted toilet seat, as shown in FIG. 1, wherein the power-assisted toilet seat is shown in an intermediate position;

FIG. 4a is a front view illustration of the power-assisted toilet seat, as shown in FIG. 3;

FIG. 4b is a side view illustration of the power-assisted toilet seat, as shown in FIG. 3;

FIG. 5 is a perspective view illustration of a power-assisted toilet seat, as shown in FIG. 1, wherein the power-assisted toilet seat is shown in the upper most position;

FIG. 6a is a front view illustration of the power-assisted toilet seat, as shown in FIG. 5;

FIG. 6b is a side view illustration of the power-assisted toilet seat, as shown in FIG. 5;

FIG. 7 is a perspective view illustration of the seat and seat support structure, and the pair of arm-rest-assemblies;

FIG. 8a is a perspective view illustration of the frame-assembly;

FIG. 8b is a perspective exploded view illustration of the frame-assembly;

FIG. 9a is a side view illustration of the power-assisted toilet seat, as shown in FIG. 1, illustrating the geometrical relationship to a user and the toilet seat;

FIG. 9b is a side view illustration of the power-assisted toilet seat, as shown in FIG. 3, illustrating the geometrical relationship to a user and the toilet seat;

FIG. 9c is a side view illustration of the power-assisted toilet seat, as shown in FIG. 5, illustrating the geometrical relationship to a user and the toilet seat;

FIG. 10a a is side view illustration of a power-assisted toilet seat, as shown in FIG. 1, having a height-adjusting-mechanism, according to variations of the present invention;

FIG. 10b is a side view illustration of a power-assisted toilet seat, as shown in FIG. 5, having a height-adjusting-mechanism according to embodiments of the present invention;

FIG. 11a is a perspective view illustration of a power-assisted toilet seat, as shown in FIG. 1, having a feet lifting device being in a down position, according to embodiments of the present invention;

FIG. 11b is a perspective view illustration of a power-assisted toilet seat, as shown in FIG. 5, having a feet lifting device being in an upper position, according to variations of the present invention;

FIG. 12a is a side view illustration of a power-assisted toilet seat, as shown in FIG. 11a, wherein the device for moving the legs and knees of a sitting person upwardly is in a down position;

FIG. 12b is a side view illustration of a power-assisted toilet seat, as shown in FIG. 11b, wherein the device for moving the legs and knees of a sitting person upwardly is in an upper position;

FIG. 12c is a side view illustration of a power-assisted toilet seat, as shown in FIG. 12b, wherein the device for moving the legs and knees of a sitting person upwardly is in an upper position, thereby bringing the person using the power-assisted toilet seat proximal to a squat position;

FIG. 13a is a bottom view illustration of a power-assisted toilet seat, as shown in FIG. 11a, wherein the leg holder is removed for illustration purposes only;

FIG. 13b is a bottom view illustration of a power-assisted toilet seat, as shown in FIG. 11b, wherein the leg holder is removed for illustration purposes only.

### DESCRIPTION OF THE PREFERRED EMBODIMENTS

Before explaining embodiments of the invention in detail, it is to be understood that the invention is not limited in its application to the details of construction and the arrangement of the components set forth in the host description or illustrated in the drawings.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

Meanings of technical and scientific terms used herein are to be commonly understood as to which the invention belongs, unless otherwise defined. The present invention can be implemented in the testing or practice with methods and materials equivalent or similar to those described herein.

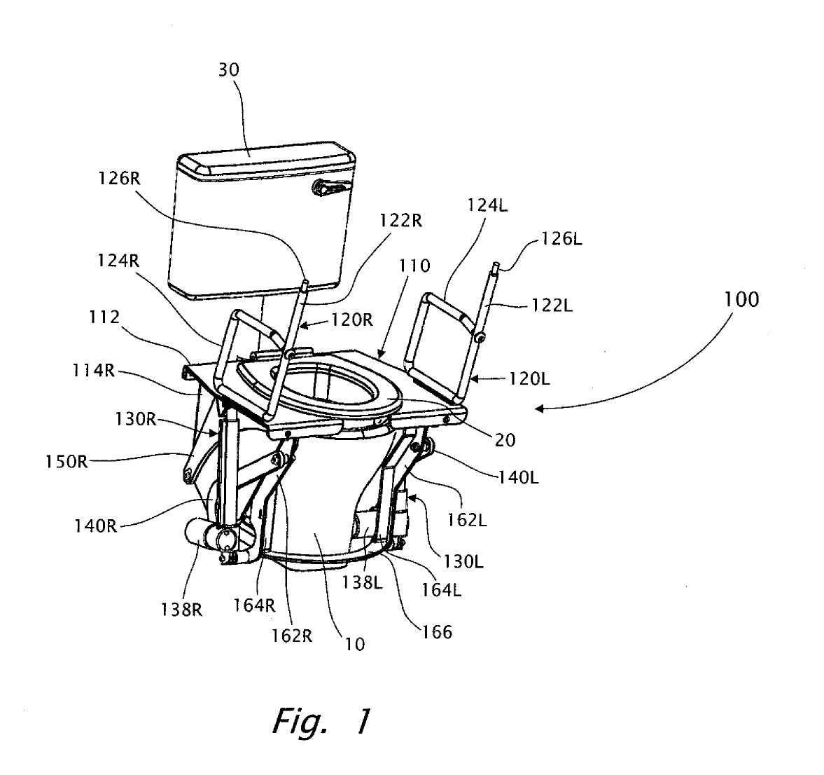

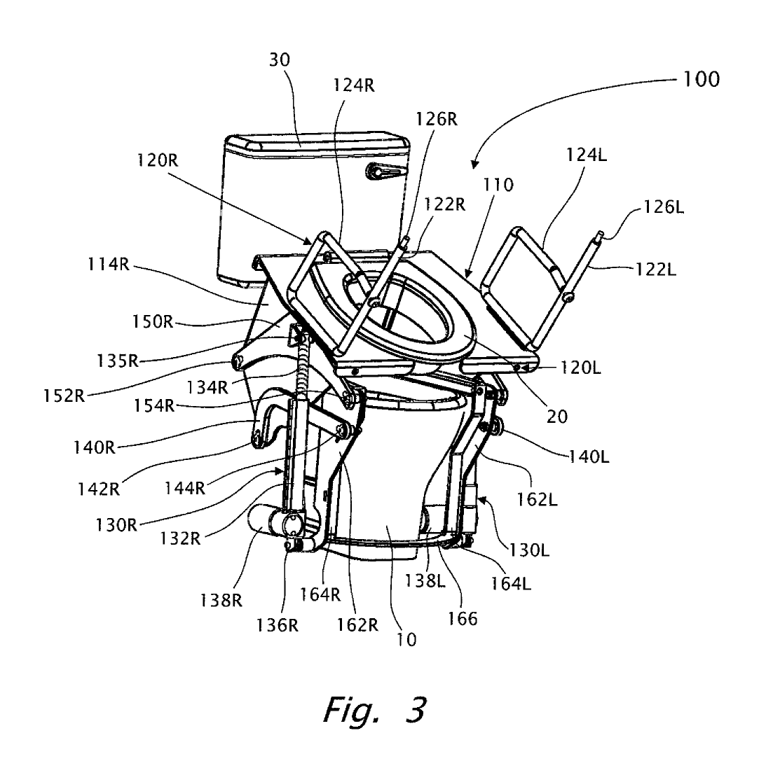

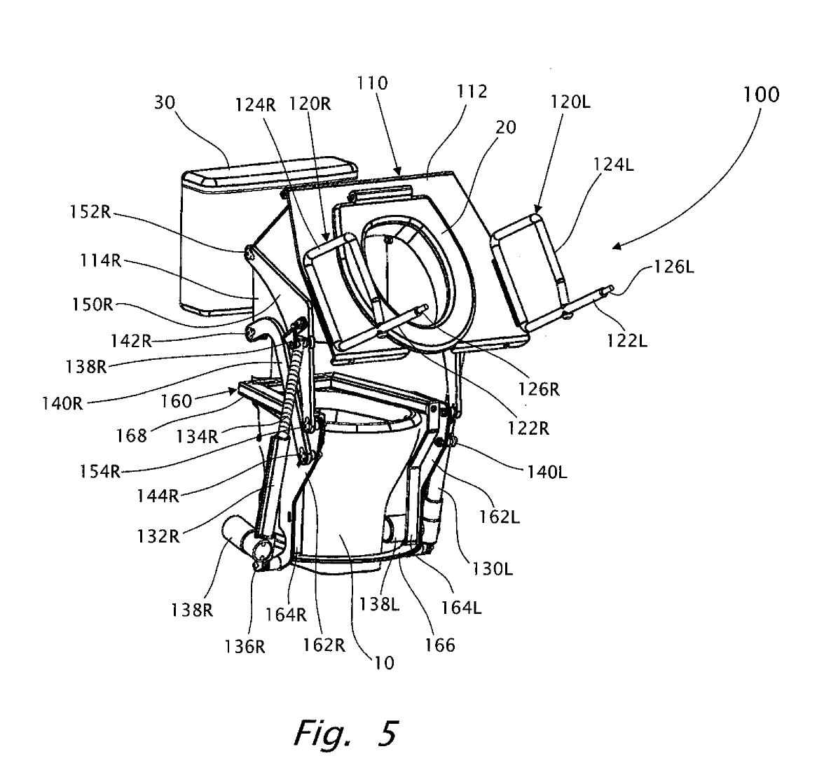

Reference is now made to the drawings. FIG. 1 is a perspective view illustration of a power-assisted toilet seat 100 for disabled persons, according to embodiments of the present invention, wherein power-assisted toilet seat 100 is shown in the lower most position. FIG. 3 is a perspective view illustration of a power-assisted toilet seat 100, wherein power-assisted toilet seat 100 is shown in an intermediate position, and in FIG. 5, power-assisted toilet seat 100 is shown in an upper most position.

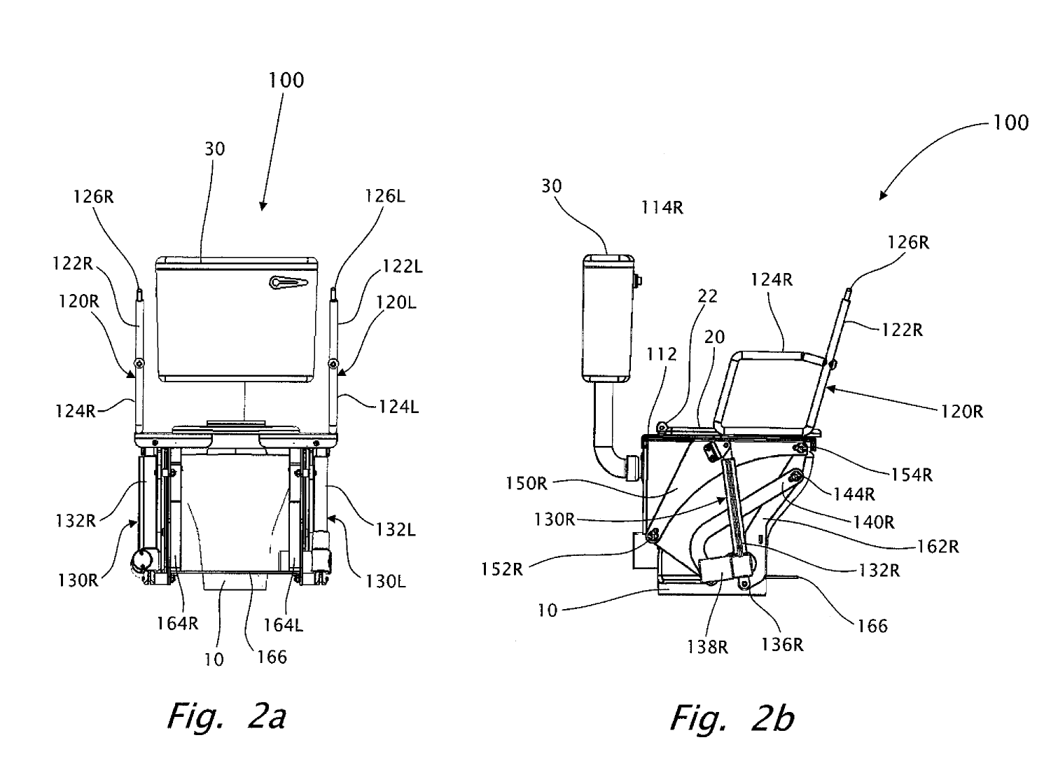

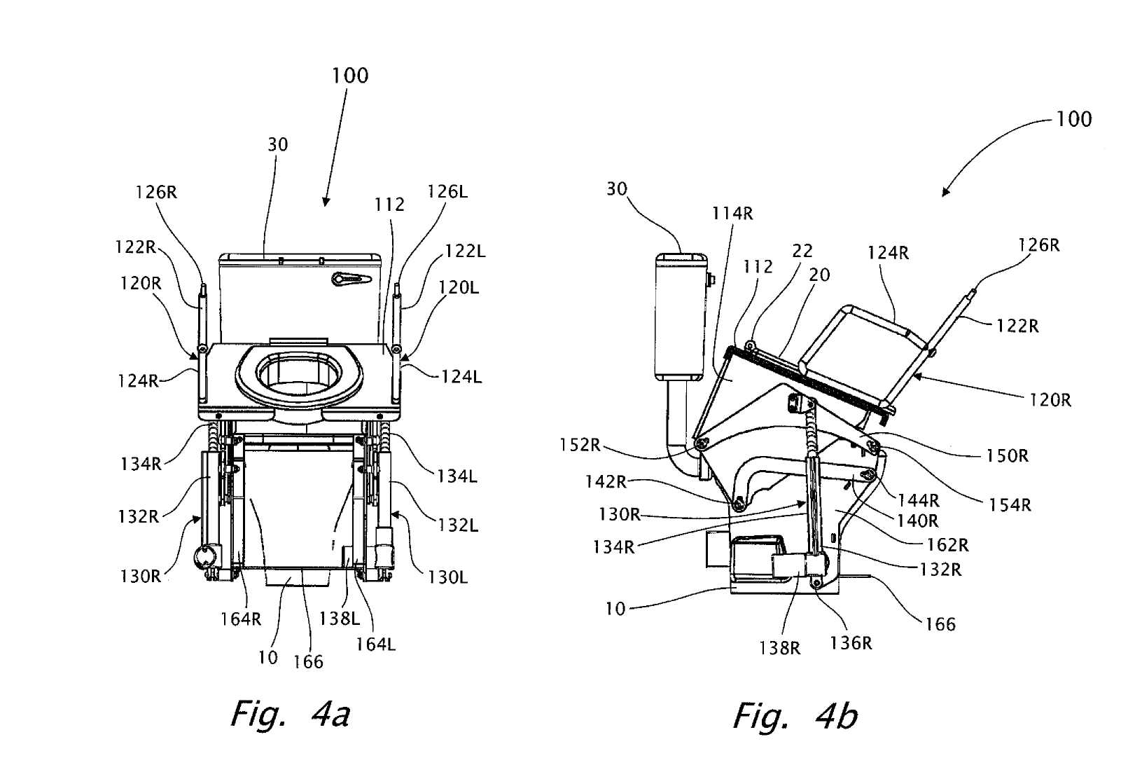

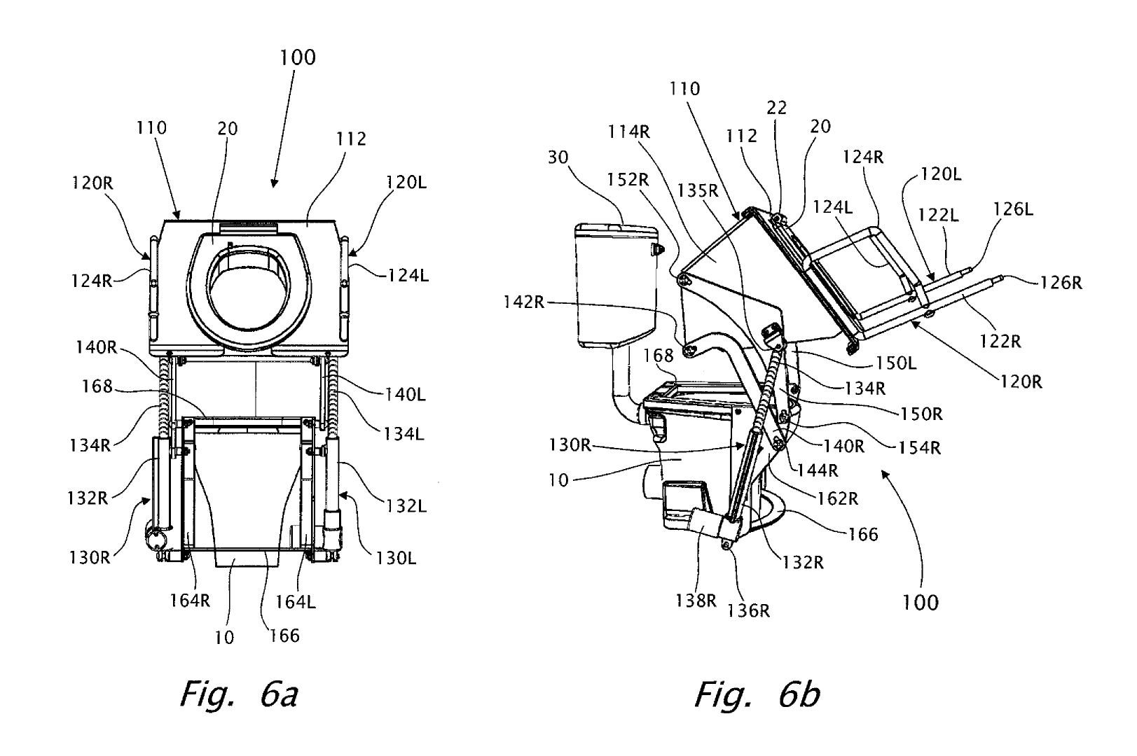

Power-assisted toilet seat 100 includes a seat-support-assembly 110, a pair of arm-rest-assemblies 120, a pair of lifting-mechanisms 130, a stationary frame-assembly 160 and a pair of sets of motion conveying arms 140 and 150. Reference is also made to FIG. 2a, a front view illustration of the power-assisted toilet seat, as shown in FIG. 1; and to FIG. 2b, a side view illustration of the power-assisted toilet seat, as shown in FIG. 1; to FIG. 4a, a front view illustration of the power-assisted toilet seat, as shown in FIG. 3; to FIG. 4b, a side view illustration of the power-assisted toilet seat, as shown in FIG. 3; to FIG. 6a, a front view illustration of the power-assisted toilet seat, as shown in FIG. 5; and to FIG. 6b, a side perspective view illustration of the power-assisted toilet seat, as shown in FIG. 5.

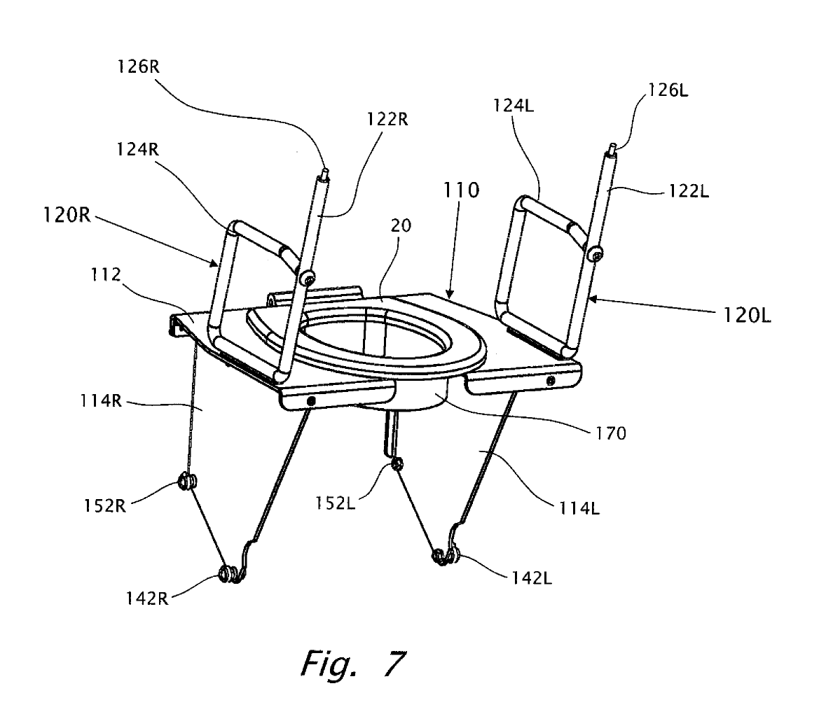

Reference is also made to FIG. 7, which is a perspective view illustration of seat 20 and seat-support-assembly 110 and the pair of arm-rest-assemblies 120. Seat-support-assembly 110 includes a seat-support-panel 112, wherein a toilet seat, typically a conventional toilet seat 20, is disposed on top of seat-support-panel 112. Seat-support-panel 112 supports toilet seat 20 to enable the seat and lid to be operatively pivoted downwardly and backwardly, when moving from an upper most position of power-assisted toilet seat 100, down to a sitting position, supported by the upper edge of toilet bowl 10. Seat-support-assembly 110 further includes a pair of vertically oriented side-walls 114, wherein seat-support-panel 112 is securely disposed onto the top edge of the respective side-walls 114R and 114L. Typically, seat-support-assembly 110 further includes a flashing water tank 30.

Arm-rest-assemblies 120R and 120L are securely disposed onto the top of surface seat-support-panel 112 on both sides of seat 20, at a convenient distance from seat 20. Each arm-rest-assembly 120 includes an arm rest 124 and a handle 122.

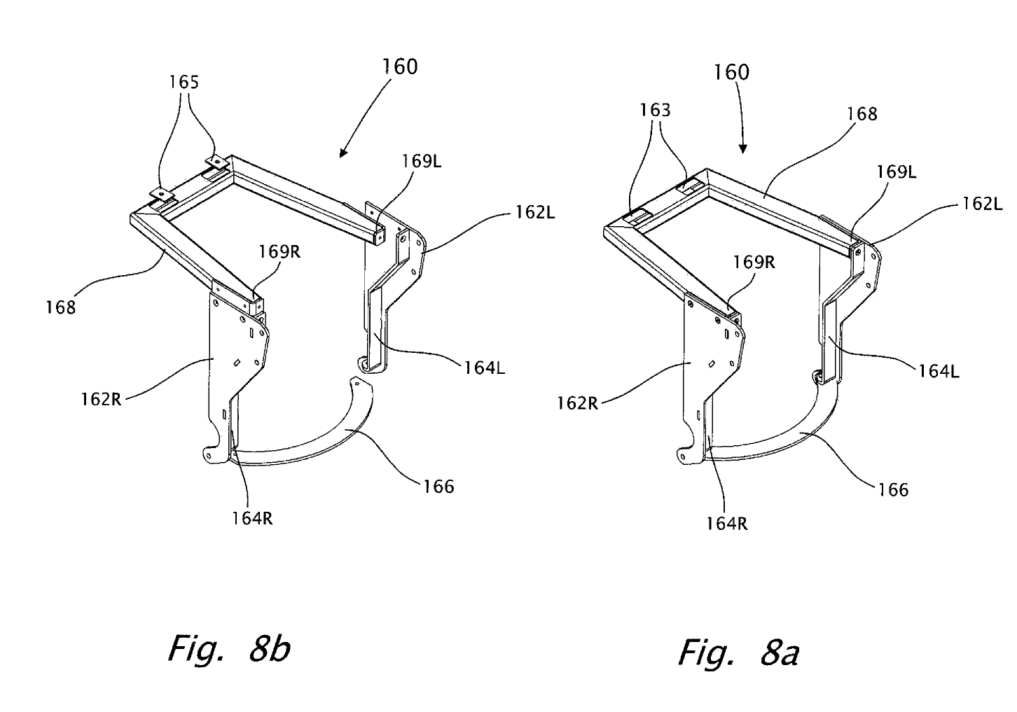

Reference is also made to FIGS. 8a and 8b, which are perspective view illustrations of frame-assembly 160. Frame-assembly 160 includes a bowl-top sub-frame 168, securely attached to the upper edge of toilet bowl 10. Bowl-top sub-frame 168 is typically U-shaped, wherein the opening is formed at the front side of the upper edge of toilet bowl 10. Typically, the rear side of bowl-top sub-frame 168 is securely attached to the upper edge of toilet bowl 10 through the common bores conventionally used to attach a conventional toilet seat 20. Frame-assembly 160 further includes vertically oriented frontal arms 162R and 162L, each securely attached to the external side of the respective frontal ends 169 of the U-shaped bowl-top sub-frame 168. Frame-assembly 160 further includes a lateral and generally horizontal bottom front leg holder 166 securely interconnected to the frontal side of the respective frontal ends 169 of the U-shaped bowl-top sub-frame 168 by vertically oriented connecting support arms 164R and 1641L.

Lifting-mechanisms 130R and 130L include a pair of generally vertical compound jackscrews that are pivotally interconnect with the respective support arms 164R and 164L, therebelow. Each lifting-mechanism 130 further includes an electric motor 138 powering each respective jackscrew 134 that are optionally controlled by a computerized feedback type circuitry for manually selectable or preprogrammed motion of the toilet seat structure. Each jackscrew 134 is protected by a housing 132. Each of the electric motor, 138R or 138L, is rotatably connected to a respective jackscrew 134. Electric motor 138 is preferably a low voltage DC or AC motor, thereby facilitating easy switch from rotating jackscrew 134 forward to rotating backward. It should be noted that the jackscrew mechanism is provided by way of example only, and other power lifting-mechanisms, such as pneumatic or hydraulic mechanisms, may be used.

Each set of motion conveying arms includes a lower-conveying-arm 140 and an upper-conveying-arm 150. Motion conveying arms 140 and 150 are shaped and disposed such as to provide toilet seat 20 an operative motion path that closely approximates the movement of the hips, buttocks, thighs, knees and lower legs which occurs when a person, being supported by toilet seat 20, moves between a standing position and a sitting position.

At a first end, lower-conveying-arm 140 is pivotely connected proximal to the lower and generally frontal (when in sitting position) end of the respective movable side-wall 114, wherein the pivoting motion is facilitated about a respective axis 142. At the second end, lower-conveying-arm 140 is pivotely connected proximal to the upper end of the respective static frontal arm 162, wherein the pivoting motion is facilitated about a respective axis 144.

At a first end, upper-conveying-arm 150 is pivotely connected proximal to the lower and generally rear (when in sitting position) end of the respective movable side-wall 114, wherein the pivoting motion is facilitated about a respective axis 152. At the second end, upper-conveying-arm 150 is pivotely connected proximal to the upper end of the respective static frontal arm 162, wherein the pivoting motion is facilitated about a respective axis 154 and wherein axis 154 is disposed proximally above axis 144. It should be noted that axis 154 is disposed at or proximal to the external side of the respective frontal ends 169 of the U-shaped bowl-top sub-frame 168, where the respective static frontal arm 162 is securely attached to the respective frontal ends 169 of bowl-top sub-frame 168. Axis 144 disposed slightly below axis 154 to facilitate free motion of motion conveying arms 140 and 150.

The lower end of the housing 132 of each of the lifting-mechanisms 130 is pivotally connected to the respective support arm 164R or 164L, proximal to the lower end of the respective support arm 164, wherein the pivoting motion is facilitated about a respective axis 136. The upper end of the jackscrew 132 of each of the lifting-mechanisms 130 is pivotally connected to the respective upper-conveying-arm 150R or 150L, proximal to the middle (proximal to the middle distance between axis 152 and axis 154) of the respective conveying arm 150, wherein the pivoting motion is facilitated about a respective axis 135.

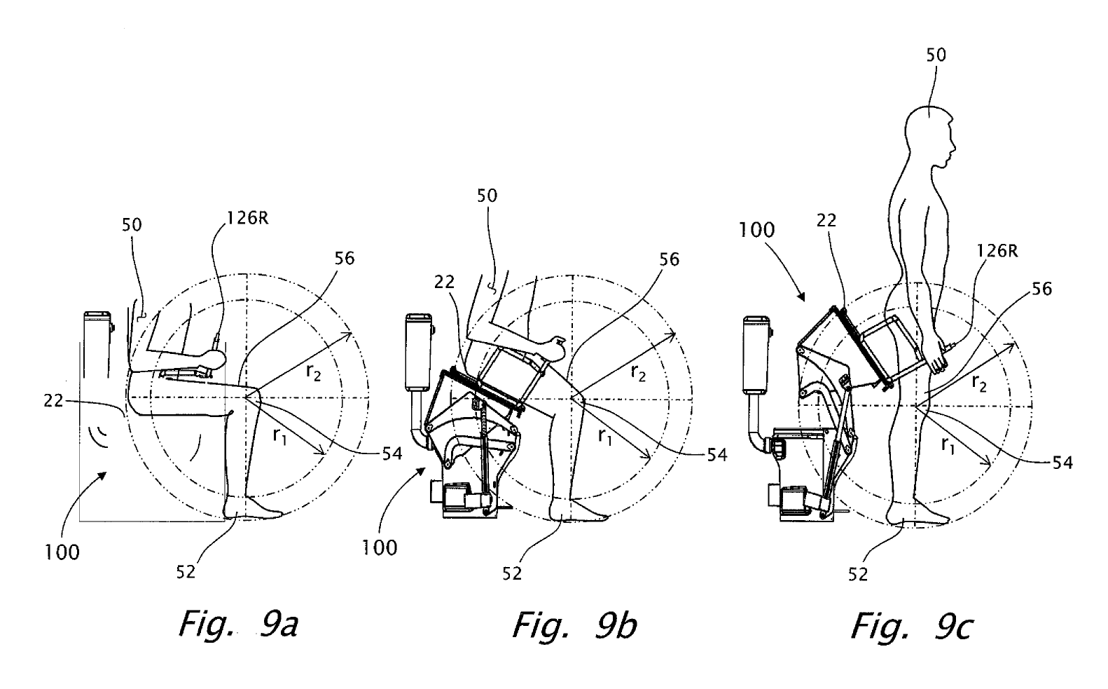

Reference is now made to FIG. 9a, which is a side view illustration of power-assisted toilet seat 100, as shown in FIG. 1, illustrating the geometrical relationship to a user 50 and power-assisted toilet seat 100 of the present invention; to FIG. 9b, which is a side view illustration of power-assisted toilet seat 100, as shown in FIG. 3, illustrating the geometrical relationship to a user 50 and power-assisted toilet seat 100 of the present invention; and to FIG. 9c, which is a side view illustration of power-assisted toilet seat 100, as shown in FIG. 5, illustrating the geometrical relationship to a user 50 and power-assisted toilet seat 100 of the present invention.

To operate power-assisted toilet seat 100, a user 50 can press a button/switch 126 disposed, for example on one or both handles 122 of a respective arm-rest-assembly 120. For example, a single switch 126 may have an OFF, UP and DOWN positions, while by using two switches 126R and 126L, one is used to operatively move seat-support-assembly 110 upwardly and the other switch is used to operatively move seat-support-assembly 110 downwardly. For description convenience only, with no limitation, the operation of power-assisted toilet seat 100 will be described in terms of using a single switch 126.

In FIG. 9a, user 50 is shown in a sitting position, whereas power-assisted toilet seat 100 is in the lower most position. In FIG. 9c, user 50 is shown in a standing position, whereas power-assisted toilet seat 100 is in the upper most position and wherein the physical effort required from user 50 to reach the standing position is minimalistic. In FIG. 9b, user 50 is shown in an intermediate state, in which state user 50 is moving between the sitting position and the standing position.

To move power-assisted toilet seat 100 from the sitting position to the standing position, user 50 activates switch 126 to lift (UP switch position) seat-support-assembly 110 upwardly. Thereby, electric motors 138R and 138L are activated to rotate jackscrew 134, for example forward, to operatively lift seat-support-assembly 110 upwardly. Preferably, as long as user 50 activates switch 126, seat-support-assembly 110 keeps moving upwardly, until reaching the end position, where seat-support-assembly 110 reaches a near standing position and electric motors 138R and 138L are deactivated. While seat-support-assembly 110 is being lifted, each jackscrew 134 moves slowly upwardly, thereby pushing upper-conveying-arm 150 upwardly. Each upper-conveying-arm 150, being rotatably attached to the lower and generally rear end of a respective movable side-wall 114, pivotely pushes seat-support-assembly 110 upwardly, while lower-conveying-arm 140 keeps seat 20 in an inclination angle that approximates the inclination angle of the rear side of the thighs of user 50, as user 50 moves from sitting position to standing position.

As seat-support-assembly 110 moves upwardly, the feet 52 of user 50 remain steady on the floor (or any other hard surface). The center of rotation of seat-support-assembly 110 is approximated to be the knees 54 of user 50. The operative motion path of toilet seat 20 is designed to closely approximate the pivotal motion of the thighs 56, pivoting about the knees 54, as toilet seat 20 moves from a sitting position to a standing position while supporting the buttocks of user 50.

Similarly, to move power-assisted toilet seat 100 from a standing position to a sitting position, user 50 activates switch 126 to lower (DOWN switch position) seat-support-assembly 110 downwardly. Thereby, electric motors 138R and 138L are activated to rotate jackscrew 134, for example backward, to facilitate the lowering of seat-support-assembly 110 downwardly. The geometry and the physics of the lowering power-assisted toilet seat 100 from a standing position to a sitting position, is the reverse motion of the lifting operation described hereabove. It should be noted that when moving power-assisted toilet seat 100 from a standing position to a sitting position, as jackscrew 134 rotate backwards the seat may move down by the weight of the seating person 50 and/or the gravity force applied to power-assisted toilet seat 100.

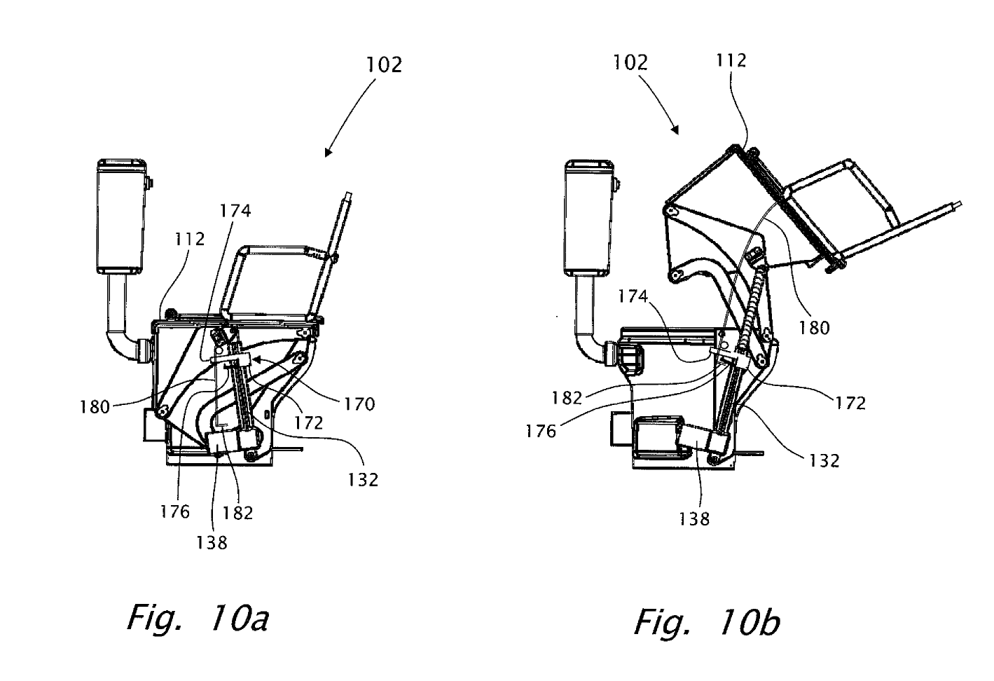

According to some embodiments of the present invention, the power-assisted toilet seat includes a height adjustment mechanism. Reference is made to FIGS. 10a and 10b, which are side view illustrations of a power-assisted toilet seat 102, as shown in FIG. 1 and FIG. 5, respectively, but also having a height-adjusting-mechanism 170. Height-adjusting-mechanism 170 includes an electric limit switch facilitated to operatively turn ON/OFF the activation power to electric motors 138. Height-adjusting-mechanism 170 is preset such that when power-assisted toilet seat 102 is moving from sitting position to standing position, a height-adjusting-mechanism 170 deactivates the power to electric motors 138 at a predesigned spatial location, thereby stopping seat-support-assembly 110 at the predesigned height, which height is typically fitted to the height of a user 50.

The electric limit switch described herein, is described by way of example only, and can be implemented in many variations, known in the art. In the examples shown in FIGS. 10a and 10b, height-adjusting-mechanism 170 includes a body 172 securely attached, for example to housing 132 of lifting-mechanisms 130. Height-adjusting-mechanism 170 further includes rigid arm 174 extending from body 172 and a flexibly contact arm 176, wherein when flexibly contact arm 176 is pushed towards rigid arm 174 and a contact is made between flexibly contact arm 176 contact arm 176 an electric circuit is closed, thereby operatively deactivating electric motors 138. It should be noted that in variations of the present invention flexibly contact arm 176 is pushed away from rigid arm 174 and thereby an electric circuit is opened to thereby operatively deactivate electric motors 138.

The example mechanism for pushing flexibly contact arm 176 towards or away from rigid arm 174 includes a semi rigid wire 180 securely attached at a first end to seat-support-assembly 110, generally above adjusting mechanism 170. Proximal to the second end of semi rigid wire 180, a rigid element 182 is securely attached to semi rigid wire 180, extending generally perpendicular to semi rigid wire 180. As seat-support-assembly 110 moves operatively upwardly, semi rigid wire 180 moves upwardly too, proximal to flexibly contact arm 176 but without actively touching flexibly contact arm 176. At a certain predesigned length of semi rigid wire 180, rigid element 182 reaches flexibly contact arm 176, and pushes flexibly contact arm 176 immediately thereafter, to thereby operatively deactivate electric motors 138.

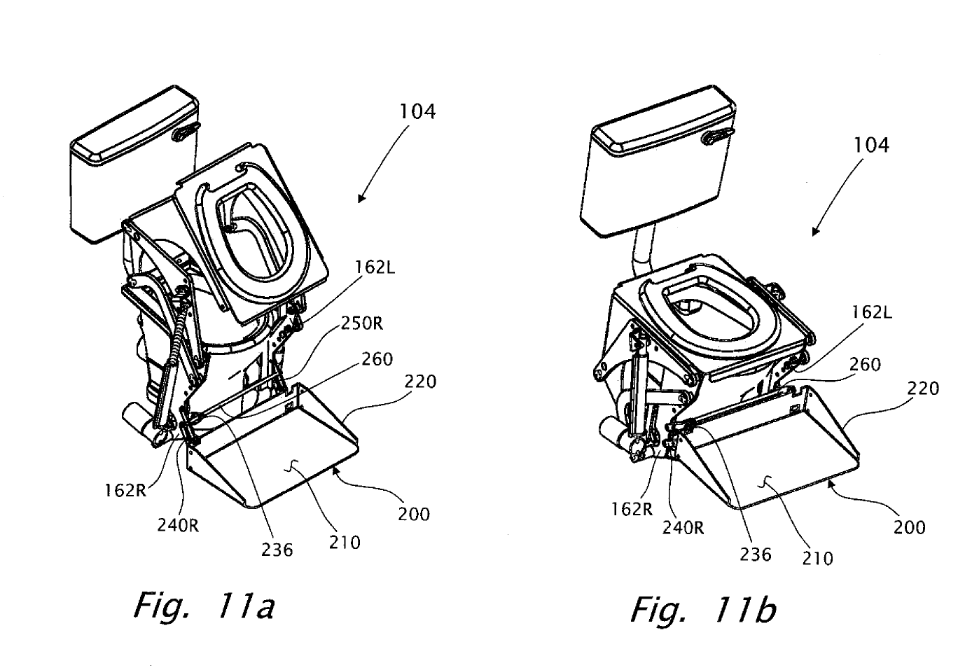

In variations of the present invention, the power-assisted toilet seat includes a device for moving the legs and knees of a sitting person 50 upwardly, thereby bringing person 50 proximal to a squat position. Reference is made to FIGS. 11a and 11b, which are perspective view illustrations of a power-assisted toilet seat 104, as shown in FIG. 1 and FIG. 5, respectively, but also having a feet-lifting-device 200, according to variations of the present invention. Feet lifting device 200 includes a lifting tray 220, having a standing plate support 210.

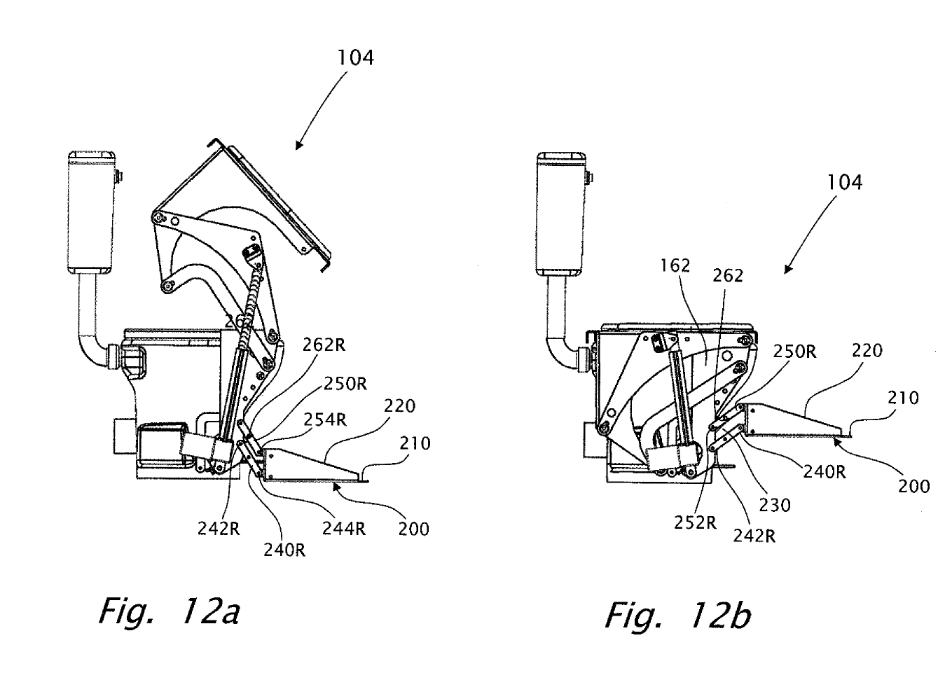

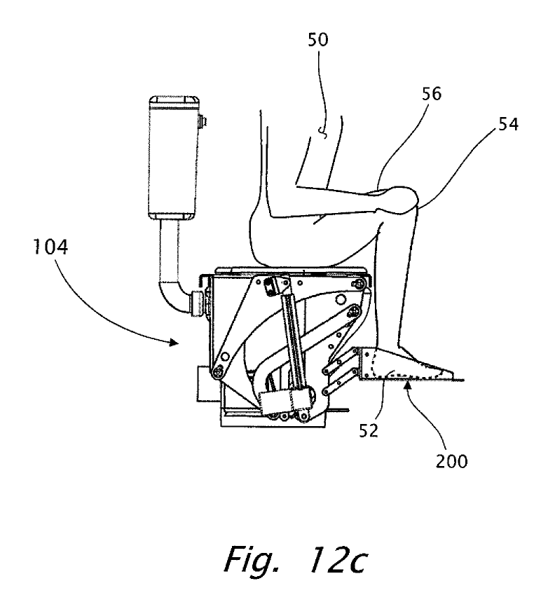

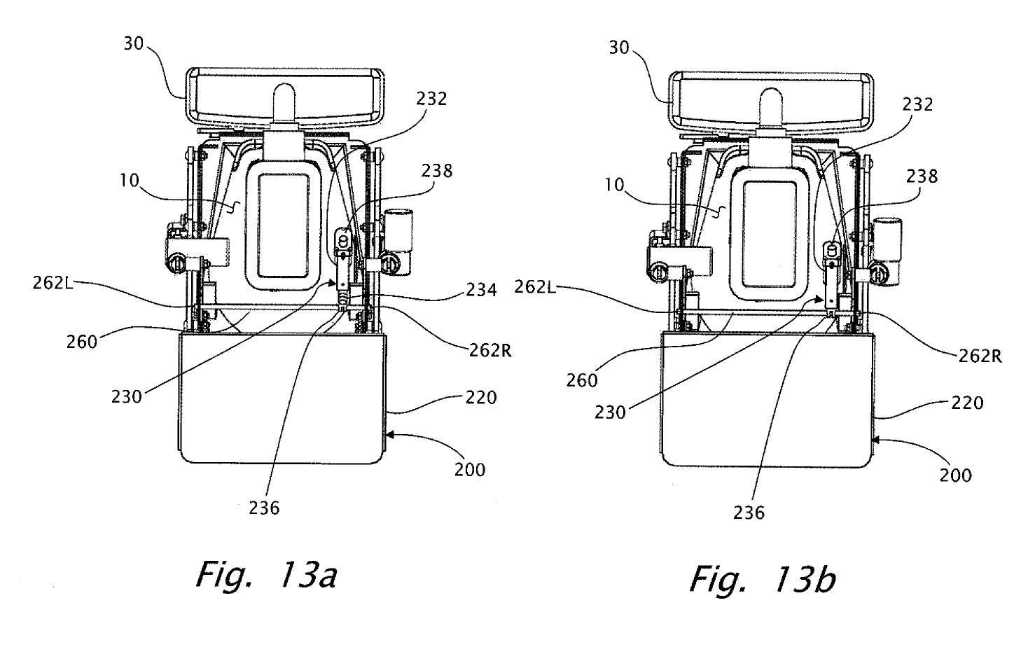

Reference is also made to FIG. 12a, which is a side view illustration of power-assisted toilet seat 104, as shown in FIG. 11a, wherein feet lifting device 200, for moving the legs and knees of a sitting person upwardly, is in a down position; to FIG. 12b, which is a side view illustration of power-assisted toilet seat 104, as shown in FIG. 11b, wherein feet lifting device 200, for moving the legs and knees of a sitting person upwardly, is in an upper position; to FIG. 12b, which is a side view illustration of power-assisted toilet seat 104, as shown in FIG. 11b, wherein feet lifting device 200, for moving the legs and knees of a sitting person upwardly, is in an upper position and thereby bringing person 50 proximal to a squat position; to FIG. 13a, which is a bottom view illustration of power-assisted toilet seat 104, as shown in FIG. 11a, wherein the leg holder is removed for illustration purposes only; and to FIG. 13b, which is a bottom view illustration of power-assisted toilet seat 104, as shown in FIG. 11b, wherein the leg holder is removed for illustration purposes only.

The feet lifting-mechanism, for moving the legs and knees of a person 50 sitting of on toilet seat 20 of power-assisted toilet seat 104, upwardly, will now be described by way of example only, and can be implemented in many variations, known in the art.

In the examples shown in FIGS. 11a-13b, feet lifting device 200 further includes one or two motors 238, a pair of sets of motion conveying arms 240 and 250, and a motion conveying bar 260. When a user 50 wants to use power-assisted toilet seat 104, lifting tray 220 is in a down position (see FIG. 11a), typically supported by the floor below.

While user 50 is sitting on toilet seat 20 in a normal manner, user 50 may lift lifting tray 220 to thereby move the feet and knees of a sitting person upwardly, thereby bringing person 50 proximal to a squat position, thereby assisting a person 50 suffering, for example, from constipation (see FIG. 12c).

Lifting-mechanisms 230 includes a compound jackscrew that is securely attached to frame-assembly 160 of power-assisted toilet seat 104. Electric motor 238 powers jackscrew 234 that is optionally controlled by a computerized feedback type circuitry for manually selectable or preprogrammed motion of the toilet seat structure. The electric motor 238 is rotatably connected to jackscrew 234. Jackscrew 234 is protected by a housing 232. Typically, an electric motor, 238 is a DC motor, thereby facilitating easy switch from rotating jackscrew 234 forward to rotating backward. It should be noted that the jackscrew mechanism is provided by way of example only, and other power lifting-mechanisms, such as pneumatic or hydraulic mechanisms, may be used.

Each set of motion conveying arms includes a lower-conveying-arm 240 and an upper-conveying-arm 250 disposed substantially parallel to each other. At a first end, lower-conveying-arm 240 is pivotely connected to static frontal arm 162 at a predetermined location, wherein the pivoting motion is facilitated about a respective axis 242. At the second end, lower-conveying-arm 240 is pivotely connected proximal to the lower end of the back side of lifting tray 220, wherein the pivoting motion is facilitated about a respective axis 254. At a first end, upper-conveying-arm 250 is pivotely connected to static frontal arm 162 at a predetermined location, wherein the pivoting motion is facilitated about a respective axis 252. At the second end, lower-conveying-arm 250 is pivotely connected proximal to the upper end of the back side of lifting tray 220, wherein the pivoting motion is facilitated about a respective axis 254.

Motion conveying bar 260 is pivotely disposed, in a lateral orientation, between a predesigned pair either lower-conveying-arms 240R and 240L or upper-conveying-arms 250R and 250L. In the example shown in FIGS. 11a-13b, motion conveying bar 260 is pivotely disposed between upper-conveying-arms 250R and 250L, wherein the pivoting motion is facilitated about respective axes 262R and 262L. The upper end of jackscrew 232 of lifting-mechanism 230 is securely connected to motion conveying bar 260, at a predesigned angel. Thereby, when jackscrew 232 pivotally pushes motion conveying bar 260, in a forward and upward direction motion conveying bar 260 pivots about axes 262.

To move lifting tray 220 upwardly, user 50 activates motor 230, for example by activating an electric switch (not shown). Thereby, electric motor 238R is activated to rotate jackscrew 234, for example forward, to operatively lift lifting tray 220 upwardly. Preferably, as long as user 50 activates the switch, lifting tray 220 keeps moving upwardly, until reaching the upper position, when electric motor 238 is deactivated. While lifting tray 220 is being lifted, jackscrew 234 moves slowly forwardly and upwardly, thereby pushing upper-conveying-arm 250 upwardly. Each upper-conveying-arm 250, being rotatably attached to static frontal arm 162, pivotely pushes lifting tray 220 upwardly, while lower-conveying-arms keep standing plate support 210 generally horizontal, as the feet and knees of user 50 move upwardly, thereby bringing him/her proximal to a squat position.

The geometry and the physics of the lowering lifting tray 220 from the upper position to the lower position, is the reverse motion of the lifting operation described hereabove.

It should be noted that side-walls 114 of power-assisted toilet seats 100, 102 and 104 prevent a “scissors” which may, in some prior art power-assisted toilet seats cut or damage fingers of a user of the power-assisted toilet seat, or any other elongated items caught between moving arms.

It should be noted that the weight of users of power-assisted toilet seats 100, 102 and 104 is limited only by the power of electric motors 138.

It should be noted that the shapes of all parts of all elements of power-assisted toilet seats 100, 102 and 104 may vary, but remain within the scope of the present invention.

In variations of the present invention, power-assisted toilet seats 100, 102 and 104 includes toilet seat accessories such as a bidet, seat heater etc.

In variations of the present invention, the power lifting-mechanism is used for power-assisted toilet seat 100 is use for moving a person between sitting and standing positions in chairs, armchairs, recliners, sofas, etc.

In variations of the present invention, one or more of the electric limit switches of power-assisted toilet seats 100, 102 and 104 are magnetic activated limit switches.

It should be noted that power-assisted toilet seats 100, 102 and 104 can be mounted on any toilet replacing the toilet seat and using the mounting holes of the toilet seat.

In variations of the present invention, power-assisted toilet seat 100 is made of modular components, to thereby provide a do-it-yourself power-assisted toilet seat kit.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the claims.

1.-11. (canceled)

12. A power-assisted toilet seat, facilitating movement of a toilet seat in a path with close approximation to the movement of the hips, buttocks, thighs, knees and lower legs of a user, the knees being the center of the pivotal motion of the thighs about the knees of the user, occurring when the user moves between a standing position and a sitting position, the power-assisted toilet seat comprising:
a seat-support-assembly comprising:
a U-shaped seat-support-panel, wherein the hands of said U-shaped seat-support-panel are pointing towards the front of the toilet seat bowl; and
side-walls;
two motion conveying arms comprising:
a lower-conveying-arm; and
an upper-conveying-arm;
a stationary frame-assembly, facilitated to securely attach to the top of the toilet seat bowl through the common bores conventionally used to attach a conventional toilet seat, said frame-assembly comprising:
a U-shaped bowl-top sub-frame disposed substantially parallel to the top rim of the toilet seat bowl, wherein the hands of said U-shaped bowl-top sub-frame are pointing towards the front of the toilet seat bowl;
two frontal arms disposed in a general vertical orientation, one on each side of the toilet seat bowl; and
a leg holder disposed at the front of the toilet seat bowl proximal and substantially parallel to the floor,
a lifting-mechanism comprising:
a pair of generally vertical compound jackscrews, wherein a bottom end of each of said jackscrews is pivotally attached to said bottom section of said frontal arm, respectively, at a preconfigured location; and wherein a top end of each of said jackscrews is pivotally attached to said upper-conveying-arm, respectively, at preconfigured locations; and
a motor, rotatably connected to said compound jackscrews; and
a power switch,
wherein said U-shaped seat-support-panel is facilitated to securely carry a conventional toilet seat;
wherein the top section of each of said frontal arms is securely attached to said bowl-top sub-frame proximal to the front end of said hands of said U-shaped bowl-top sub-frame;
wherein the bottom section of each said frontal arms is securely attached to a respective end of said leg holder;
wherein a rear end of each of said lower-conveying-arm is pivotally attached to the bottom section of said side wall, respectively, at a preconfigured location; and wherein a front end of each of said lower-conveying-arm is pivotally attached to the top section of said frontal arm, respectively, at a preconfigured location;
wherein a rear end of each of said upper-conveying-arm is pivotally attached to the bottom section of said side wall, respectively, at a preconfigured location; and wherein a front end of each of said upper-conveying-arm is pivotally attached to the top section of said frontal arm, respectively, at a preconfigured location;
wherein said power switch is in operational communication with said motor, facilitating activating said compound jackscrews to thereby move a user seating on said U-shaped seat-support-panel between said standing position and said sitting position.

13. The power-assisted toilet seat as in claim 12 further comprising: at least one arm-rest-assembly.

14. The power-assisted toilet seat as in claim 13, wherein said power switch is disposed at preconfigured location on each of said arm-rest-assemblies.

15. The power-assisted toilet seat as in claim 14, wherein said preconfigured location is conveniently accessible to the user.

16. The power-assisted toilet seat as in claim 12, wherein the power-assisted toilet seat comprises a pair of motors, each operatively coupled with one of said compound jackscrews.

17. The power-assisted toilet seat as in claim 12, wherein said motor is an AC or DC electric motor.

18. The power-assisted toilet seat as in claim 12, wherein rotating said motor in a first direction, lifts said U-shaped seat-support-panel from said sitting position to said standing position, and wherein rotating said motor in a second direction, lowers said U-shaped seat-support-panel from said standing position to said sitting position.

19. The power-assisted toilet seat as in claim 12 further comprising:
a height adjustment mechanism, comprising a rigid element and a flexible contact arm, wherein said rigid element is operatively connected to said U-shaped seat-support-panel;
wherein said flexible contact arm is in operational communication with said motor; and
wherein when said U-shaped seat-support-panel reaches a preconfigured height, said rigid element activates said flexible contact arm to thereby deactivate said motor.

20. The power-assisted toilet seat as in claim 12 further comprising:
a feet-lifting-device for moving the legs and knees of a sitting person upwardly, the device comprising:
a lifting-tray;
a tray-lifting mechanism; and
an activating-switch,
wherein said tray-lifting mechanism is in operational communication with said lifting-tray; and wherein said activating-switch is in operational communication with said tray-lifting mechanism.

21. The power-assisted toilet seat as in claim 20, wherein said tray-lifting mechanism comprises:
a motion conveying bar;
motion conveying arms;
a second-jackscrew; and
a motor, wherein activating said activating-switch activates said motor to rotatably activate said second-jackscrew, to thereby push motion conveying bar in a forward and upward direction, to thereby pivot motion conveying arms upwardly and thereby, move said lifting-tray in a generally vertical upward direction.

22. The power-assisted toilet seat as in claim 21, wherein rotating said motor in a first direction, lifts said U-shaped seat-support-panel from said sitting position to said standing position, and wherein rotating said motor in a second direction, lowers said U-shaped seat-support-panel from said standing position to said sitting position.
